(19) United States
(12) Patent Application Publication
(10) Pub. No.: US 2006/0251777 A1
(43) Pub. Date: Nov. 9, 2006

(54) Interlocking edible sideliner for cake decoration, method, three-dimensional cake sculpture method and product

(76) Inventor: Debra L. Koplish, Newfoundland, NJ (US)

Correspondence Address: Kenneth P. Glynn, 24 Mine Street, Flemington, NJ, 08822, US

(21) Appl. No.: 11/444,013

(22) Filed: May 31, 2006

Related U.S. Application Data
(63) Continuation-in-part of application No. 10/635,350, filed on Aug. 6, 2003, now abandoned.

(51) Int. Cl. A23G 3/28

(52) U.S. Cl. 426/383

(57) ABSTRACT

An interlocking edible interlocking sideliner product may include an optional separate or attached bottom liner. An edible baked base has a bottom, substantially vertical walls, and a top. There is also a mass produced, edible three-dimensional cupcake sculpture, or cake sculpture product that includes: a.) an edible baked base having a bottom, substantially vertical walls and a non vertical top; and, b.) an edible three dimensional sculpture presenting a distinguishable scene, the sculpture has two portions, first portion is three dimensional and is located on the non-vertical top of the base, and second is two dimensional and is located on the substantially vertical walls of the base. In some preferred embodiments, the second portion includes at least one edible substrate and at least one edible printed segment of the distinguishable scene on the substrate. There is also an interlocking edible sideliner and an optional separate or attached bottom liner.

### REFERENCES TO RELATED APPLICATIONS

This application is a continuation in part of copending U.S. application Ser. No. 10/635,350, filed on 6 Aug. 2003 by the same inventor herein, entitled “THREE-DIMENSIONAL CAKE SCULPTURE METHOD AND PRODUCT”.

### BACKGROUND OF THE INVENTION

1. Field of the Invention

The present invention relates to baked products, and, more particularly, to baked products having unique edible sideliners and bases, methods of assemblage and use, and to three dimensional presentations of scenes, e.g. stylized busts, animals, holiday themes, and the like. The present invention is both the methods and the products, wherein, in some embodiments, liners are created flat and are shaped, connected and filled with cake material for cooking; in other embodiments, the top of the cupcake or cake has a three dimensional presentation and the side has a continuation of the presentation in two dimensions. In other preferred embodiments, the present invention is directed to interlocking edible cake sideliners, alone, with separate edible bases and with attached edible bases.

2. Information Disclosure Statement

The following patents relate to decorative baked products:

U.S. Pat. No. 2,895,832 describes a novelty cake comprising a baked cake having a recess in its upper surface, an edible sheet bearing an edible design applied on the surface of said sheet disposed in said recess, and a layer of transparent gelatin disposed over said sheet and filling most of the recess in said cake.

U.S. Pat. No. 3,503,345 describes a method for decorating a cake by pre-forming a disk of icing, freezing the disk so that it hardens to facilitate handling, and then placing it on the cake so that it softens to from the top of the cake.

U.S. Pat. No. 4,285,978 describe a method whereby decorative designs and the like can be formed upon baked goods by transferring a preprinted design from a transfer material to an uncooked dough surface. In one embodiment the dough surface is first covered with a thin layer of flour preparatory to transferring a water-soluble ink design to the dough. In a preferred embodiment after the dough is baked a liquid glaze is applied to the surface thereof for imparting a decorative and protective coating to the baked goods. The process of the invention is suitable for both hand and automated operation.

U.S. Pat. No. 5,035,914 describes a food for snack or as use as a breakfast cereal which has a creamy orange flavor. The food product includes a popped cereal which is selected from oat, wheat, rye, soy, corn, rice and combinations of these and essentially includes a powdered dairy or dairy substitute product which simulates cream flavor in combination with powdered orange or artificial orange flavor. Preferred embodiments include sweeteners such as fructose, sugar, corn syrup, dextrose, artificial sweeteners and combinations of these. Further, the food may include preservatives as well as vitamin and mineral supplements. In one embodiment, the puffed cereal is formed in a shape of a sphere.

U.S. Pat. No. 5,534,281 describes an apparatus and a method for making printed foods such as cookies, crackers, and snacks at high production speeds on a continuous basis. The apparatus includes a rotary printer which is synchronized with dough forming apparatus such as a rotary cutter or rotary molder.

U.S. Pat. No. 6,295,758 describes a wrapper for wrapping about a floral grouping and a method for wrapping the floral grouping, the wrapper having a handle formed from a portion of the sheet of material for carrying the wrapper with the floral grouping disposed therein. The wrapper may comprise one or more sheets of material. The sheet may have more than one handle portion formed thereon.

U.S. Pat. No. 6,432,461 describes an edible cake decoration comprising a sugarpaste formulation including at least one humectant. A method of forming the decoration is also disclosed which includes exposing the sugarpaste to a humid environment. An apparatus for use in the method is also disclosed which comprises a blister having a profiled surface and plurality of ventilation holes therein, which blister forms a template for use in the vacuum forming of the wet sugarpaste to provide a 3-D shape to the decoration, the sugarpaste being dried after vacuum forming.

U.S. Pat. No. 6,432,462 describes edible decorations which reproduce all types of patterns, including colored patterns. The purpose of these decorations is partially or totally to cover the cakes for which they are intended and with which they form a perfectly homogenous whole. More precisely, the invention comprises in producing a printed decoration with five successive layers: a first layer of printed edible paper, and a second layer of material for modifying the texture of the edible paper and sticking the first and third layers together. The third layer comprises of a material belonging to the group comprising almond paste and chocolate. The fourth layer is equivalent to the second layer, and the fifth layer is equivalent to the first layer. By virtue of this innovation, a printed decoration does not detract from the cake and remains supple and homogenous.

Notwithstanding the prior art, the present invention is neither taught nor rendered obvious thereby.

### SUMMARY OF THE INVENTION

In some embodiments, the present invention is a three dimensional cake sculpture product. The term “cake sculpture” refers to any cake that has a sculpture presentation. “Cake” means a product that is made from batter and is baked. In other embodiments, the present invention is an interlocking cake sideliner, alone or with a separate bottom or an attached bottom.

In some preferred embodiments, the present invention interlocking cake sideliner includes a flat sheet of bakeable edible substrate, being a sideliner having at least four sides, including a top edge, a bottom edge, a first end and a second end, the first end having a first interlocking member and the second end having a second interlocking member that is interlockable with the first interlocking member. In some preferred embodiments, the interlocking cake sideliner flat sheet has a general footprint shape, excluding the interlocking members, selected from the group consisting of rectangular, trapezoidal, parallelogram, and curved top and bottom trapezoidal.

In some preferred embodiments, the flat sheet has a first interlocking member that is one of a male and a female member and the second end having a second interlocking member that is the other of a male and a female member and is interlockable with the first interlocking member.

In some preferred embodiments, the flat sheet has a thickness of about 1/100 inch to about ⅜ inch, and preferably about 1/20 inch to about ⅛ inch and is made of a material selected from the group consisting of flatbread, crepe, pancake, wafer, sugar wafer, rice paper, pie crust, pita, cornmeal, unleavened bread.

In some preferred embodiments, the flat sheet has a distinguishable scene printed thereon in bakeable edible print. For any prints or designs, any known edible dye or food coloring may be used. Such inks include any certified United States Food & Drug Administration food colorings.

In some preferred embodiments, the flat sheet has a distinguishable scene printed thereon in bakeable edible print, and the sideliner further includes edible topping decoration that is complementary to the distinguishable scene. In some preferred embodiments, the interlocking cake sideliner further includes a separate flat sheet of bakeable edible substrate bottom having a shape and size compatible with an open bottom created when the wherein the flat sheet sideliner ends are interlocked with one another. In some preferred embodiments, the flat sheet sideliner and the bottom have interlocking features that are complimentary. In some preferred embodiments, the interlocking cake sideliner further includes a connected flat sheet of bakeable edible substrate bottom having a shape and size compatible with an open bottom created when the wherein the flat sheet sideliner ends are interlocked with one another. The flat sheet sideliner and the bottom preferably have interlocking features that are complimentary.

The present invention also includes the method of making a cake product. The essential steps are:
a.) providing a flat sheet of bakeable edible substrate, being a sideliner having at least four sides, including a top edge, a bottom edge, a first end and a second end, the first end having a first interlocking member and the second end having a second interlocking member that is interlockable with the first interlocking;
b.) interlocking the sideliner and placing it on a bakeware device;
c.) pouring bakeable cake material into the sideliner on the bakeware device and baking until baked.
   In some preferred embodiments, the method is wherein the flat sheet has a general footprint shape, excluding the interlocking members, selected from the group consisting of rectangular, trapezoidal, parallelogram, and curved top and bottom trapezoidal. In some preferred embodiments, each of the features of the product set forth above, separately or in combination, are included in the method.

In some preferred embodiments, the present invention product includes: a.) an edible baked base having a bottom, substantially vertical walls, and a top; and, b.) an edible three dimensional sculpture presenting a distinguishable scene, the sculpture has two portions, being a first portion and a second portion. The first portion is three dimensional and is located on the top of the base, and the second portion is two dimensional and is located on the substantially vertical walls of the base. In some preferred embodiments, the second portion includes at least one edible substrate and at least one edible printed segment of the distinguishable scene on the substrate.

In some preferred embodiments of the present invention three dimensional cake sculpture product, the first portion is selected from the group consisting of cake icing, cookies, wafers, jelly beans, candy and combinations thereof positioned to create a segment of the distinguishable scene.

In some preferred embodiments, the distinguishable scene is a head presentation of a stylized person, e.g., a head presentation of a stylized person including a top as the first portion and facial features as the second portion. The top may be selected from the group of three dimensional tops, consisting of hair, ears, headwear and combinations thereof.

In other embodiments of the present invention three dimensional cake sculpture product, the distinguishable scene is at least a part of a stylized animal.

In other embodiments, the present invention three dimensional cake sculpture product includes an edible baked base and a three dimensional sculpture presenting a distinguishable scene, the sculpture being of two portions, the first portion being edible and being three dimensional and being located on the top of the base, and the second portion being inedible and being two dimensional and being located on the substantially vertical walls. In some embodiments, the second portion includes at least one inedible substrate and at least one inedible printed segment of the distinguishable scene on the substrate.

The present invention also relates to a method of making a three-dimensional cake sculpture product (“cake” means any cake product, including cupcake). The method includes the steps of a.) making an edible baked base in a shape having a bottom, substantially vertical walls and a top; and b.) creating a three dimensional sculpture of a distinguishable scene on the base by applying a first portion of the sculpture to the top of the base in the form of a three dimensional portion of the sculpture, and applying a second portion of the sculpture to the substantially vertical walls in a flat, smooth, two dimensional outer surface. In some embodiments, the second portion is an edible portion having an edible substrate and at least one edible printed segment of the distinguishable scene on the substrate. In other embodiments, the second portion is an inedible peelable portion containing at least one printed segment of the distinguishable scene.

For example, the methods may include the sculpture being created by applying at least one application of cake icing and at least a second application of a decoration selected from the group consisting of another cake icing, cookies, wafers, jelly beans, candy and combinations thereof. The edible baked base may be made by baking in a baking pan having a predetermined shape to create the bottom of the substantially vertical walls, and the non-vertical top or it could be cut or shaped after being baked.

### BRIEF DESCRIPTION OF THE DRAWINGS

The present invention should be more fully understood when the specification herein is taken in conjunction with the drawings appended hereto wherein:

FIGS. 1, 2, 3, and 4 show a front view of various children's busts in the form of sculptured cake;

FIGS. 5, 6, 7, and 8 show present invention cakes with sculptured animal presentations;

FIGS. 9, 10, 11, 12, 13, 14, 15, and 16 illustrate present invention sculptured cakes with holiday themes, including 4^{th} of July, Halloween, Christmas, Easter, and Thanksgiving;

FIG. 17 shows a happy clown birthday present invention sculptured cake;

FIG. 18 shows present invention sculptured cake in the form of an animal with horns;

FIGS. 19, 20, 21, and 22 show present invention sculptured cupcakes with smiling children;

FIGS. 23, 24, 25, 26, 27, 28, 29, and 30 show various sculptured animal cakes;

FIGS. 31 and 32 show a porpoise and a crab underwater as present invention sculptured cakes;

FIGS. 33, 34, 35, and 36 show sculptured animal cakes;

FIGS. 37 and 38 show sculptured Halloween scary cakes;

FIGS. 39, 40, 41, 42, and 43 illustrate sculptured anima cakes;

FIG. 44 shows a vampire sculptured cake;

FIGS. 45, 46, 47, 48, 49, and 50 illustrate various pests and bugs as sculptured cakes;

FIGS. 51 and 52 show fire truck and train action three dimensional cake sculptures;

FIGS. 53 and 54 illustrate three dimensional sculptured sport cakes;

FIGS. 55 and 56 illustrate present invention cakes with children's fantasy sculpture;

FIGS. 57, 58, 59, and 60 show three dimensional sports cupcakes;

FIGS. 61, 62, 63, 64 and 65 show front views of present invention interlocking sideliners in full or partially cut views;

FIGS. 66 through 69 show various views and components of some embodiments of a present invention interlocking sideliner with a separate, insertable bottom member;

FIG. 70 shows a front view of one embodiment of a present invention edible bakeable interlocking sideliner with an attached bottom member and with repeated print design thereon; and,

FIGS. 71 and 72 show front views of two additional embodiments of a present invention interlocking sideliner with different shapes and printed designs thereon.

### DETAILED DESCRIPTION OF THE PRESENT INVENTION

The present invention cupcakes and cakes present exciting sculptures to children and adults in a new form never before used. The cakes have flat (two dimension) printed presentations on their sides and three dimensional sculptures on their tops wherein the tops and sides together complete a single scene. Now that the invention has been disclosed, an infinite number of possibilities emerge. The following examples illustrate the invention.

FIG. 1 shows a sculptured cake 1 with a child's head with a baseball cap. Sculptured cake 1 has a top 2 in the form of a three dimensional baseball cap made of frosting. It includes jelly bean button 3 and a cookie visor 4. The sidewall 5 has a printed paper wrap with face 6 printed thereon. It extends from top 2 down to bottom 7. In this embodiment, the sidewall 5 is inedible, although it could readily be an edible film wrap with edible film print thereon. Edible film is well known for dissolvable mint strips and edible print has been used on lollipops for decades.

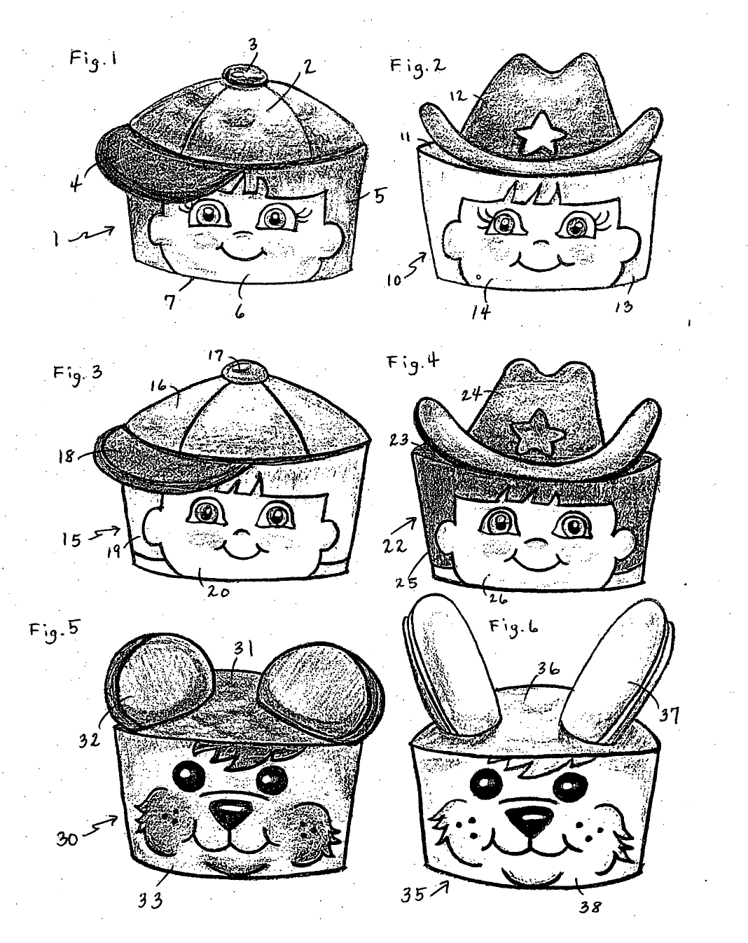

FIG. 2 shows present invention sculptured cake 10 with a molded sheriff's hat 12 on top 11 and an edible face 14 on substantially vertical sidewall 13.

FIG. 3 shows a sculptured cupcake with top 16 in the form of blue molded frosting with a butter rum button 17 and a cookie visor 18. Sidewall 19 includes a face representation 20.

FIG. 4 shows another present invention sculptured cake 22 with a top 23 and a sheriff's hat 24, with an edible strip 25 with a printed child's face and hair 26.

FIG. 5 shows present invention sculptured cake dog 30 with cookie ears 32 on top 31 and a dog face on sidewall printed sheet 33.

FIG. 6 shows present invention sculptured cake dog 35 with cookie ears 37 on top 36 and a dog face on sidewall printed sheet 38.

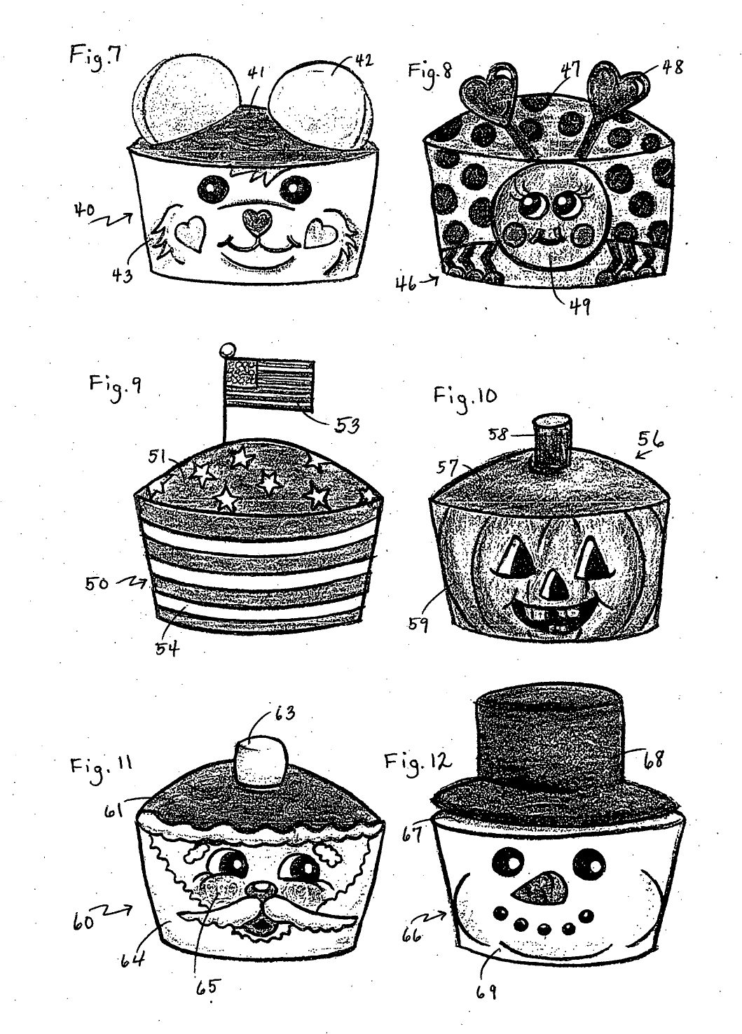

FIG. 7 shows a valentine's cub present invention sculptured cake 40 with top 41 and ears such as cookie 42, and sidewall printed sheet 43.

FIG. 8 present invention sculptured cake 46 with top 47 and heart antennas 48, and with printed edible sidewall sheet 49 to collectively create a ladybug.

FIG. 9 shows a cupcake 50 with stars and a blue background top 51 with flag 53. Sidewall 54 includes a printed edible gel sheet 54 with red and white flag stripes.

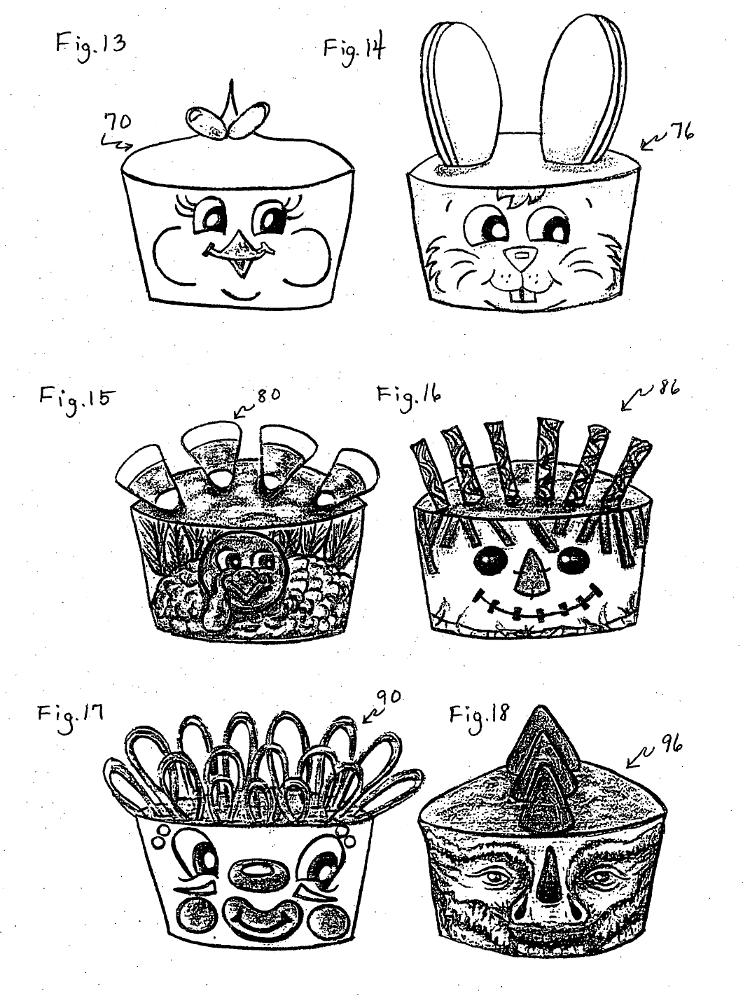

FIG. 10 shows present invention sculptured cake pumpkin 56 with top 57 having a stem 58 (e.g. a root beer barrel) and sidewall 59 in the form of an edible pumpkin face.

FIG. 11 shows a present invention sculptured cake Santa 60 with top hat 61 and marshmallow 63 and a sidewall 64 that is an edible film with a Santa face 65 printed thereon.

FIG. 12 shows present invention sculptured cake snowman 66 with top 67 and candy molded top hat 68 and a printed sidewall sheet 69 with a snowman face printed thereon.

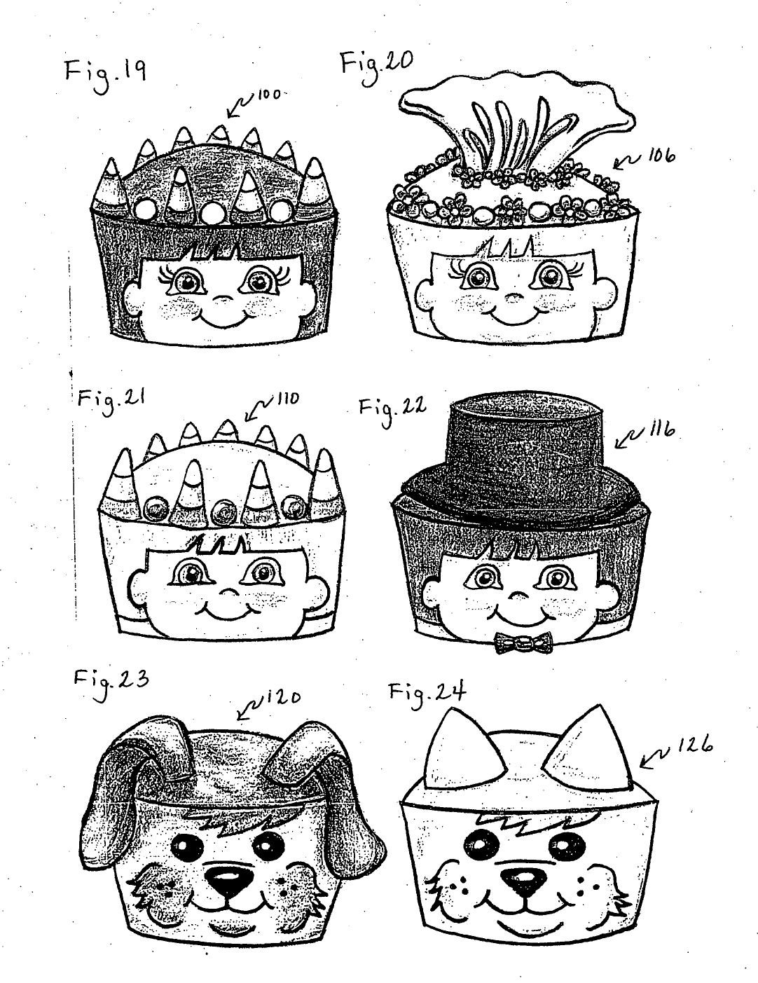

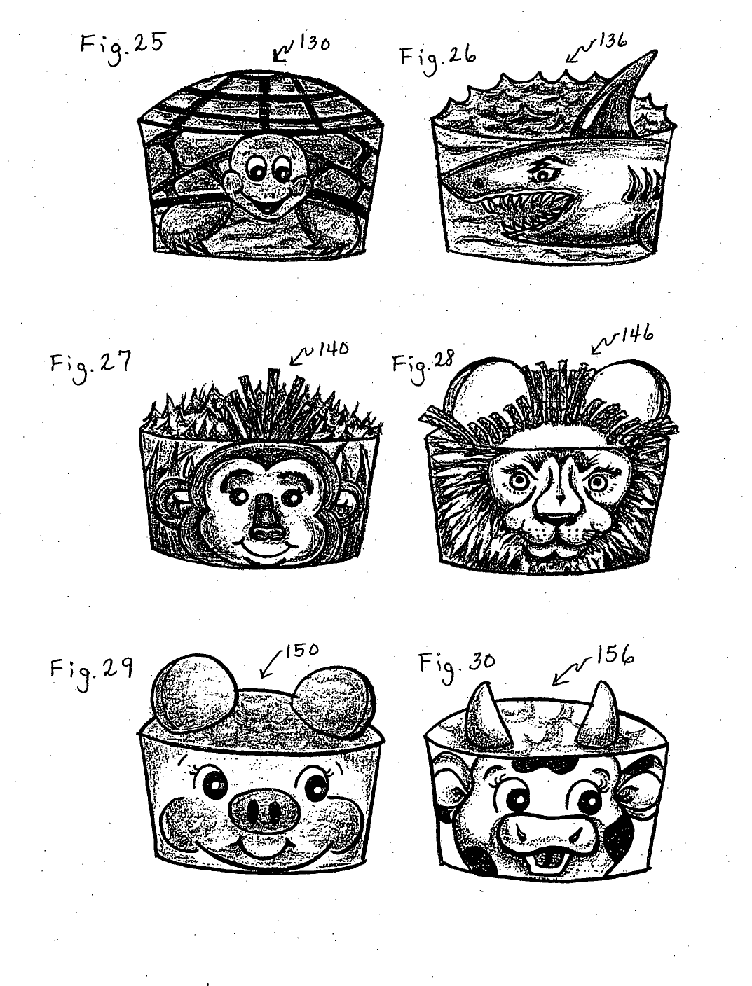

FIGS. 13, 14, 15, 16, 17, 18, 19, 20, 21, 22, 23, and 24 show present invention sculptured cakes 70, 76, 80, 86, 90, 96, 100, 106, 110, 116, 120, and 126, all showing various sculptured presentations with sidewall sheets with two dimensional printing and tops with three dimensional sculptured creations utilizing such edibles as molded or shaped icing, jelly beans, wafers, candy corns, pretzel sticks, string candy, chocolate kisses, flowers, beads and other edible components.

FIGS. 25, 26, 27, 28, 29, and 30 show present invention sculptured cakes 130, 136, 140, 146, 150, and 156, all showing various sculptured presentations with animals.

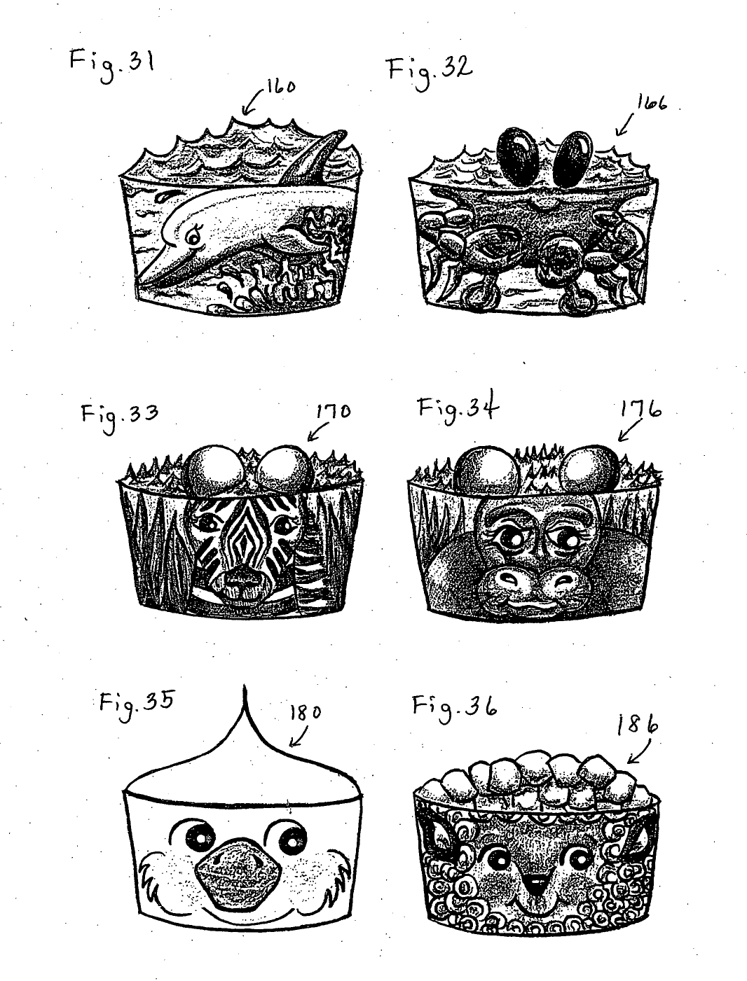

FIGS. 31 and 32 show present invention sculptured cakes 160 and 166 of a porpoise and a crab underwater, respectively.

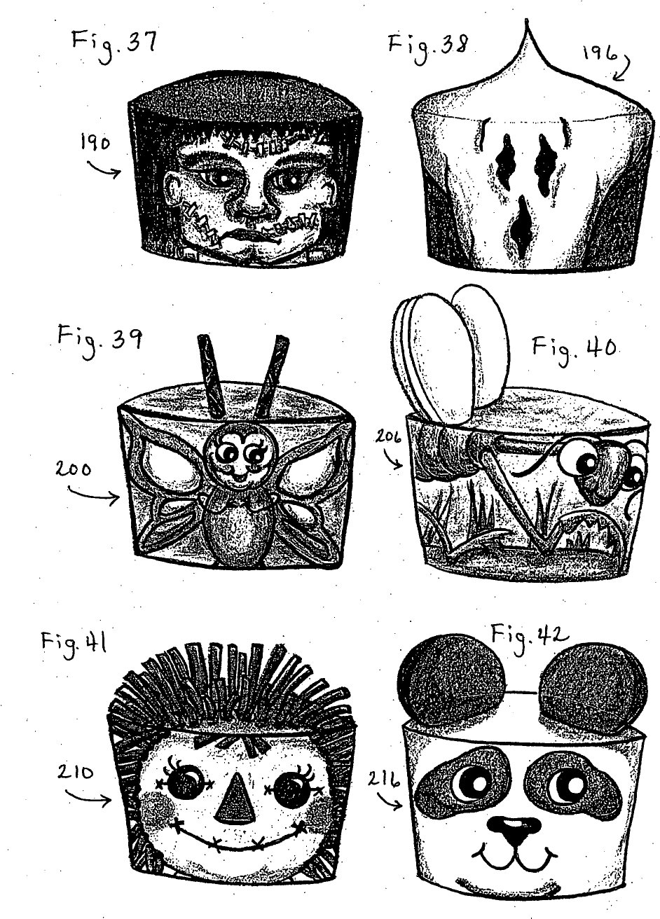

FIGS. 33, 34, 35, and 36 show present invention sculptured cakes 170, 176, 180, and 186 of various animals,

FIGS. 37 and 38 show present invention sculptured cakes 190, and 196 of Halloween scary designs.

FIGS. 39, 40, 41, 42, and 43 show present invention sculptured cakes 200, 206, 210, 216, and 220 of various animals.

FIG. 44 shows a present invention sculptured cake 226 of a vampire.

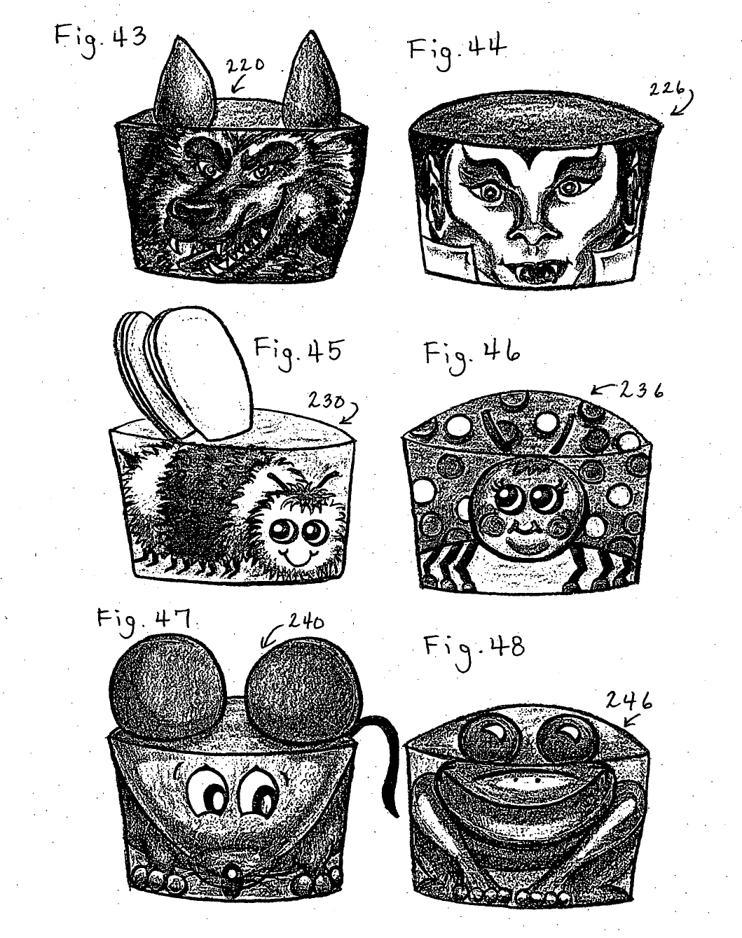

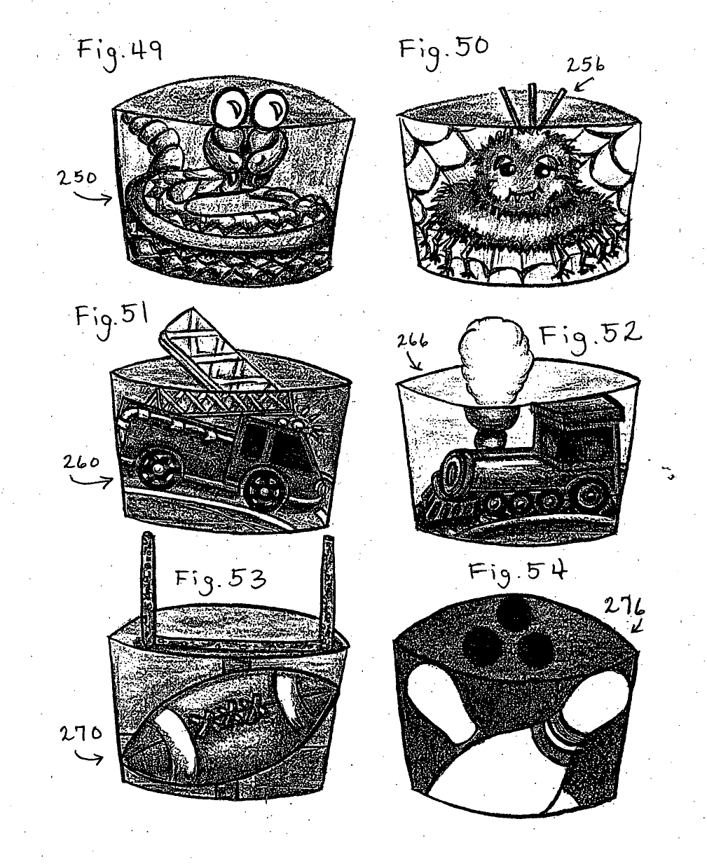

FIGS. 45, 46, 47, 48, 49, and 50 show present invention sculptured cakes 230, 236, 240, 246, 250, and 256 of various pests and bugs.

FIGS. 51 and 52 show present invention sculptured cakes 260, and 266 of a truck and train engine, respectfully.

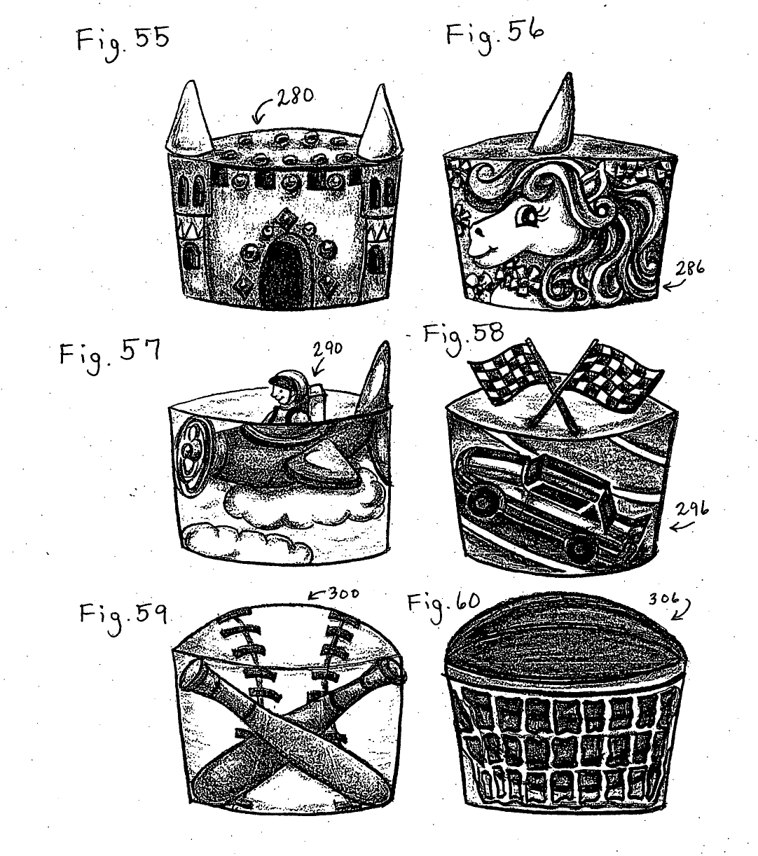

FIGS. 53 and 54 show present invention three dimensional sculptured cakes 270 and 276 of various sports.

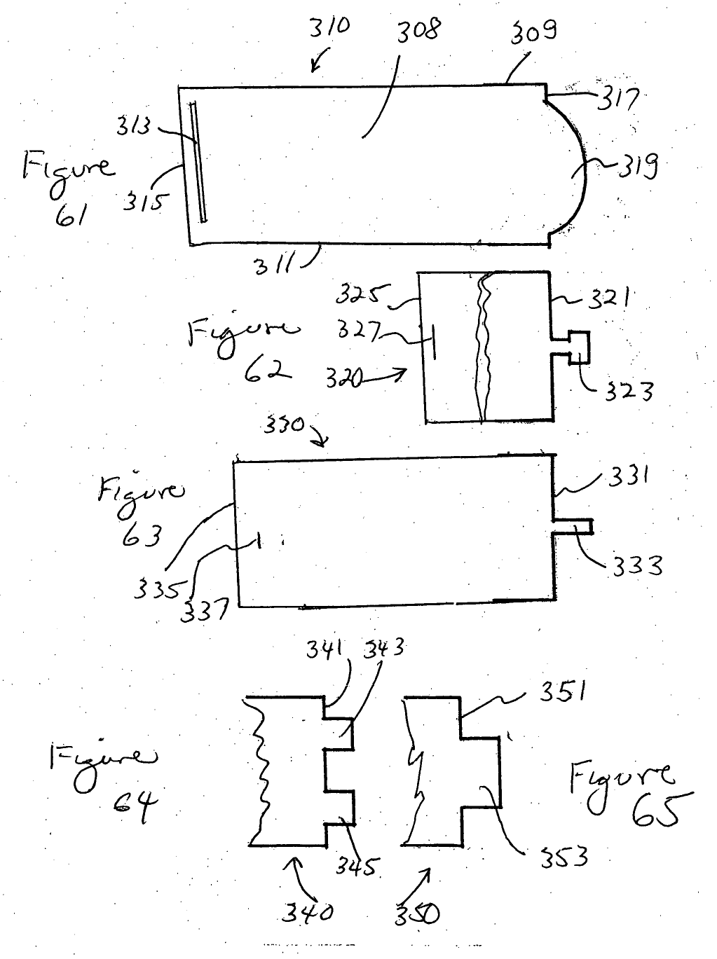

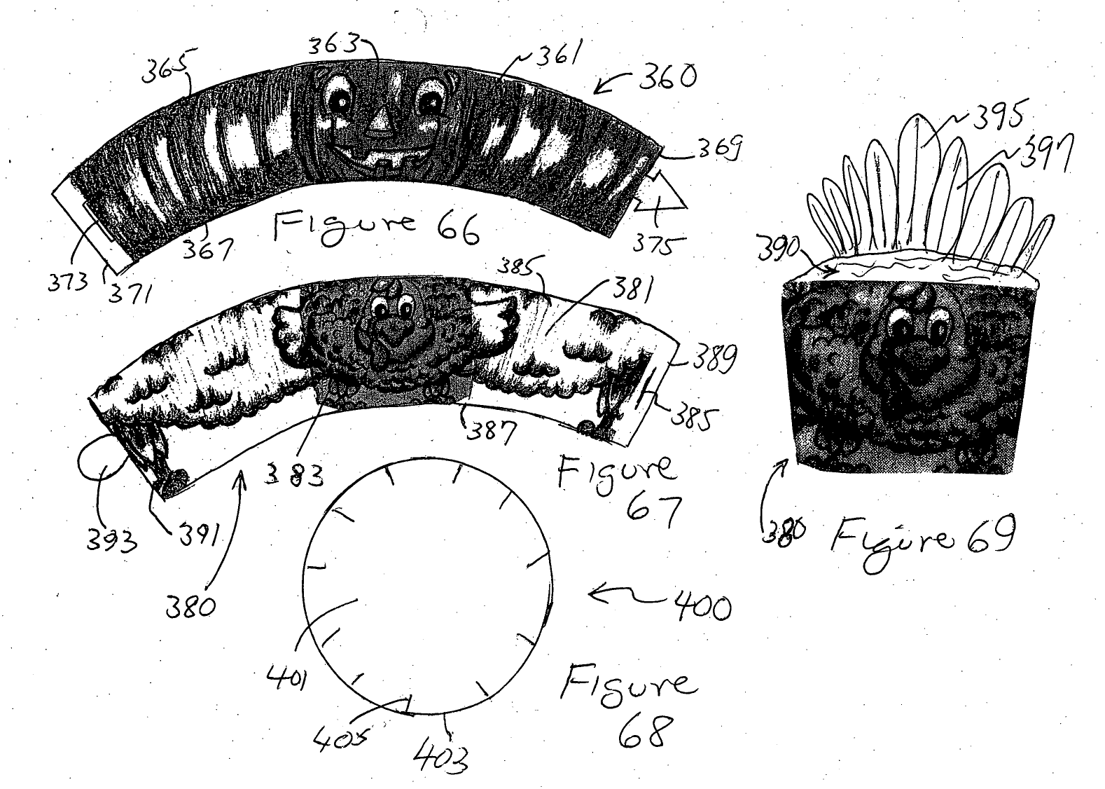

FIGS. 55 and 56 show present invention sculptured cakes 280 and 286 of various children's fantasies.

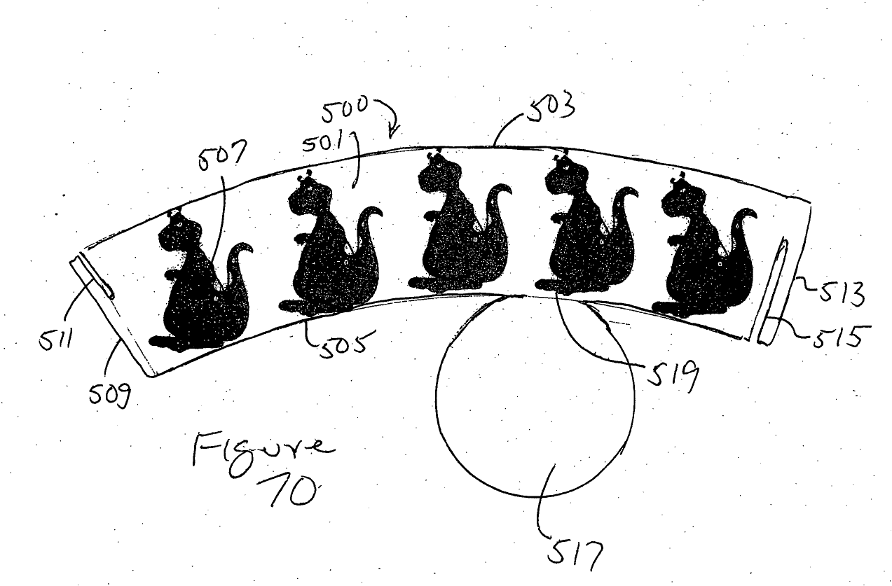

FIGS. 57, 58, 59, and 60 show present invention three dimensional sculptured cupcakes 290, 296, 300, and 306 of various sports.

FIGS. 61, 62, 63, 64 and 65 show front views of present invention interlocking sideliners in full or partially cut views. These sideliners are used to pour batter or other baking goodie therein, and are interlocking cake sideliners, made of a flat sheet of bakeable edible substrate, being a sideliner having at least four sides, including a top edge, a bottom edge, a first end and a second end, said first end having a first interlocking member and said second end having a second interlocking member that is interlockable with said first interlocking member.

FIG. 61 shows a flat rectangular present invention sideliner 310 that is a sheet 308 with top and bottom edges 309 and 311, a first end 317 with a first interlocking member 319, being a male portion, and a second end 315 with a second interlocking member 313, being a female member. This sideliner 310 may be shaped with creases into a square, a rectangle or even a triangle, or it may be curved into a continuous loop, with member 319 being inserted into female member 313. The sideliner may be filled and baked and will be edible after baking. The below described sideliners are similarly assembled and the process is not repeated for each embodiment as assemblage and usage, just having been described, is now self-evident.

FIG. 62 shows a flat rectangular present invention sideliner 320 with a first end 321 with a first interlocking member 323, being a male buckle portion, and a second end 325 with a second interlocking member 327, being a female slot member.

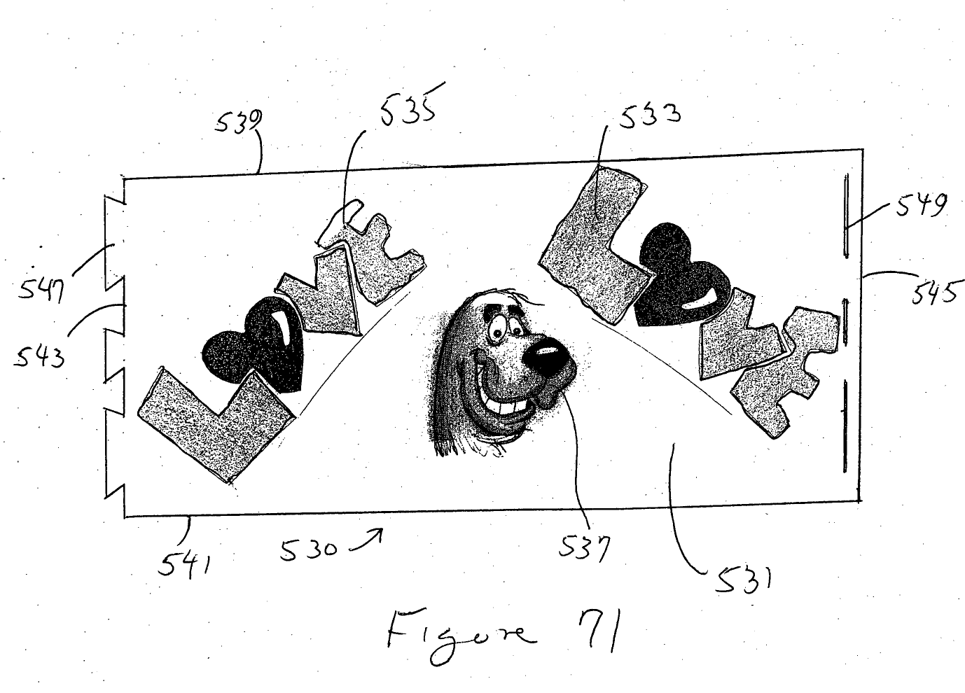

FIG. 63 shows a flat rectangular present invention sideliner 330 with a first end 331 with a first interlocking member 333, being a straight male buckle portion, and a second end 335 with a second interlocking member 337, being a female slot member. FIG. 64 shows an alternative embodiment sideliner 340 partial view with male member double buckles 343 and 345 at end 431, and FIG. 65 shows an alternative embodiment sideliner 350 partial view with a large male buckle 353 at end 351.

FIGS. 66 through 69 show various views and components of some embodiments of a present invention interlocking sideliner with a separate, insertable bottom member. FIG. 66 shows a flat curved rectangular present invention Halloween sideliner 360 that is a sheet 361 with top and bottom edges 365 and 367, a first end 369 with a first interlocking member 375, being a male portion, and a second end 371 with a second interlocking member 373, being a female member. This sideliner 360 may be shaped into a continuous loop, with member 319 being inserted into female member 313 so as to create a pumpkin presentation with edible print 363 showing the pumpkin design.

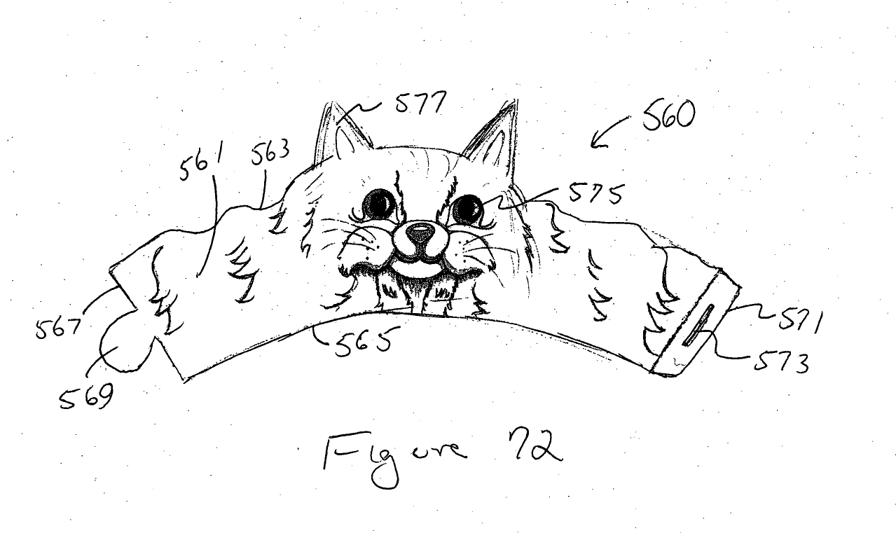

FIG. 67 shows a flat curved rectangular present invention turkey sideliner 380 for Thanksgiving that is a sheet 381 with top and bottom edges 385 and 387, a first end 389 with a first interlocking member 355, being a female portion, and a second end 391 with a second interlocking member 393, being a tab male member. This sideliner 380 may be shaped into a continuous loop, with member 393 being inserted into female member 385 so as to create a pumpkin presentation with edible print 383 showing the turkey design, as shown in FIG. 69. The bottom insert 400, shown in FIG. 68, has a solid area 401 and an outer edge 403 with slits, serrations or ridges so that the insert 400 has a slightly larger diameter than the inside of sideliner diameter when interlocked as in FIG. 69 so that the insert 400 may be pushed into the interlocked sideliner 380 and the periphery will yield to create holding force. The result is an edible, bakeable cup that is filled with cake batter and baked. Also shown in FIG. 69 are turkey tail feathers 395, 397, etc. that are made of the same material as the present invention sideliners and are also edible and bakeable.

FIG. 70 shows a front view of one embodiment of a present invention edible bakeable interlocking sideliner 500 with an attached bottom member 517 attached at area 519 and typically formed integrally as part of the product. Flat sheet, curved edge, rectangular present invention sideliner 500 has top and bottom edges 503 and 505, a first end 509 with a first interlocking member 511, and a second end 513 with a second interlocking member 515. This sideliner 500 is shaped into a continuous loop, with member 511 and 515 being hooked into one another. The bottom is then folded up to meet the bottom periphery of the sideliner 500 and it is placed on a baking pan or tray, filled and baked.

FIGS. 71 and 72 show front views of two additional embodiments of present invention interlocking sideliners with different shapes and printed designs thereon. In FIG. 71, sideliner 530 has top and bottom edges 539 and 541, a first end 543 with first interlocking members 547, and a second end 545 with second interlocking members 549, being female members. This sideliner 530 has printed character and word representations 533, 535 and 537, as shown, and is shaped into a continuous loop, with members 547 and 549 being interconnected with one another. In FIG. 72, kitten sideliner 560 has top and bottom edges 563 and 565, a first end 567 with first interlocking member 569, and a second end 571 with second interlocking member 573, being female members. This sideliner 560 has an arcuate top and bottom and when assembled takes the shape of a typical cupcake, i.e., a truncated inverted cone. It also has a printed kitten character 575 and upwardly extending ears, i.e. ear 577, as shown. It is shaped into a continuous loop, with interlocking members 569 and 573 being interconnected with one another.

The present invention flexible, flat, edible, bakeable sideliners have now been described in detail, and the following examples of recipes are amongst the choices of materials for the present invention sideliners. While in some cases they appear typical, they have more or less been modified or supplemented to be more flexible than conventional cookie, Asian pancake, etc. recipes, in some instances.

Sugar Cup Wafers (Like a Sugar Cone) Partially Baked in Flat Sheets

Ingredients:

100% Light wheat flour (bread flour)

40% Powdered sugar

1% Liquid lecithin

10% Double refined oil

0.2% Salt

QS Flavoring substance (i.e. powdered vanilla)

QS Coloring substance (liquid caramel)

100% Water

All ingredients are based on percentage points of wheat flavor weight.

Directions:

Combine all dry ingredients. Add water and mix thoroughly with a mixer (egg beater) on low speed until the batter is “smooth.” Then add double refined oil. If liquid lecithin is used, pre-mix it thoroughly with the oil or before adding to the other ingredients.

Recipe determines:

When eggs are added to the batter, the wafer product will become more spongy and its taste will be improved. 2 eggs per Kg of flour

Use batter within 1-2 hours

This will produce 1 Kg of finished sheets.

Wafer Sheet Batter (Par-Baked in Flat Sheets)

Ingredients:

7.5 Kg Wheat flour

150 gms Maize starch

100 gms Powdered sugar

180 ml Fat

20 gms Soy lecithin liquid

40 gms Sodium bicarbonate and Ammonium bicarbonate (3:1)

2 gms Sodium metabisulphide

20 gms Salt

12 Litres Water

Directions:

Put the water in a mixer.

Add soy lecithin liquid, sodium bicarbonate and ammonium bicarbonate (3:1) and salt.

Start the mixer, add the starch and then slowly add small quantity of flour in intervals.

After the wheat flour is fully mixed, add the fiat and lecithin emulsion (preferably pre-warmed)

Mix for a couple of minutes (approx. 3-4 minutes) will smooth

Strain through a sieve wire mesh to remove lumps.

The ready mix will keep good for about 2-3 hours

Dough Preparation:

Wafer quality depends on the accuracy of the dough, as far as weighing and mixing are concerned. During mixing, the consistency changes due to material dissolving and swelling, gluten development and reactions with other raw material, including air. Mixing process is complete, when a certain consistency is reached, a uniform mixing that allows for a smooth flow of the dough on the baking plates. Leave the dough for 5 minutes, and afterwards, pass it through a sieve in order to hold back the particles that have not dissolved completely. The dough will swell again. If flour with higher level of coarsely ground grain is used, the dough should be left for about 10 minutes. The longer the dough can rest; the better will be its flow. This is referred to as natural slackening of the dough. After the optimum recipe has been found out, it should be modified by the master baker.

Mixing the dough.

High Speed Mixers are best suited for beating the wafer dough Depending on the type of machine and the charge volume, the mixing period is between 3 and 10 minutes. Sufficient beating is also important for a gleaming surface of the wafer sheet without any pores.

One-stage procedure:

All components, including water are portioned directly in the mixer.

Multi-stage procedure:

Mix the whole dry matter with about half of the liquid. Add the remaining liquid afterwards at your own discretion, until the suspension shows adequate flow. All raw material and additives except the flour are beaten together with the remaining amount of liquid, until they are mixed thoroughly. After that, the flour is mixed in together with the remaining liquid.

Temperature:

The dough should have a temperature of 20-25 degree C. While being prepared warmer dough tends to turn sour due to the addition of soda, if it is stored intermediately. The temperature of the pouring wafer is adjusted according to the temperature of the flour and the mixer.

Material process during mixing:

The important process during mixing is dissolving and swelling of the flour components. This is decisive for the quality of the baking process and the wafer sheet and for the energy demand during baking; the water added during dough preparation has to be vaporized again during baking.

Important advice for the preparation of the wafer batter:

Use smooth wheat flour with medium content of gluten.

Depending on the quality of the flour, the amount of water should be increased or decreased, as every type of flour has different soaking characteristics.

In order to get a wafer sheet of good quality, the batter should not be too dilute.

Preparation of the oil/fat-lecithin emulsion:

Oil/fat should be heated lukewarm Lecithin should be added slowly and stirred until it dissolves completely. The quality of the emulsion should correspond to the batter recipe used. Then it is poured into the readily prepared wafer batter and stirred.

Mandarin Pancakes (Chinese Recipe)

Ingredients:

2 cups Flour

¾ cup Boiling water

2 tbsp. Sesame oil

Directions:

Place flour in a bowl. Add boiling water, stirring with chopsticks or a fork until dough is evenly moistened. On a lightly floured board, knead dough until smooth and satiny, about 5 minutes. Cover and let rest for 30 minutes.

On a lightly floured board, roll dough into a cylinder; cut into 16 equal pieces.

Roll each piece into a ball, then flatten slightly into a pancake, brush top of each pancake with a light coating of sesame oil.

Place 1 pancake on top of a second pancake, oiled sides together. With a rolling pin, roll to make a circle 6 inches in diameter. Stack and roll remaining pairs of pancakes the same way. Cover with a damp cloth to prevent drying.

Place a nonstick frying pan over medium heat until hot. Add 1 pair of pancakes and cook, turning once, until lightly browned and bubbles appear on the surface, about 2 minutes on each side. Remove from pan and separate into 2 pancakes while still hot. Stack cooked pancakes on a plate while cooking re pairs of pancakes.

Chapatti/Roti (Indian Flat Bred Partially Baked)

Ingredients:

2.5 cups Chapatti flour with

1 cup Water at room temperature made into dough

1 cup Chapatti flour in a large plate for dusting the dough while rolling it out

Ghee for brushing bread

Method to roll dough:

Prepare the desired amount of dough from the Basic Dough recipe. After resting for 2-2½ hours, knead well. Divide the dough into peach-size balls. On a lightly floured surface, flatten one ball of dough with your hand. Using a rolling pin, roll out the dough into a thin, round patty, about 5 inches in diameter. Roll from the center, turning patty several times to prevent sticking. Try to make the edges slightly thinner than the center. As you cook the chapatti/roti one could be roiling out the next, rather than shaping all of the chapattis at one time. Preheat a cast-iron tawa over medium heat. Place the rolled dough on the palm of one hand and flip it over on to the tawa. When the color changes on the top and bubbles appear, it will be partially baked. Use kitchen tongs (chimta) to remove the chapatti from the skillet.

Chapatti/Roti Substitutes (Partially Baked)

Wheat and malted barley flours

Use equal parts of whole-wheat flour and all-purpose flour OR use equal parts of malted barley and all-purpose flour

Cornmeal Crepes (Par-Baked)

Ingredients:

1 cup Cornmeal

½ tsp. Salt

½ cup Flour

1 Egg

2 cups Water

Additional egg content may be added to increase flexibility of the par-baked product.

Mix ingredients together and warm a pan with butter.

Pour batter into pan half a ladle at a time.

Partially cook.

Edible Wafer Liners

Liners are dried, not baked.

Ingredients:

80% Potatoes

15% Water

5% Rapeseed oil

Inks:

Propylene glycol

FD and C yellow #5 and #6

Red #3 and #40

Blue #1

Certified FDA colors

Pita Bread (Partially Cooked)

Ingredients:

3½ cups (875 ml) All-purpose flour

1 cup (350 ml) Water

1 Tbs (15 ml) Olive oil

2 Tbs (10 ml) Salt

1½ tsp (7 ml) Instant yeast

Directions:

Combine all ingredients in electric food processor, adding a little more water or flour if necessary to form a slightly sticky ball. Turn onto floured surface and knead for 1 minute. Place in a greased bowl cover loosely with a towel and allow to rise until doubled in volume, about 2 hours. Punch down and divide into 6 to 12 pieces. Keep pieces lightly floured and covered. Flatten each piece into a 6″ to 8″ disk in diameter. Place on baking stone or sheet that has been heated in a 500 degree F. (260 degree C.) oven for 1 minute to par-bake.

Naan (Flat Bread from India) (Par-Baked)

Servings 14 pieces

Ingredients:

0.25 oz Active dry yeast

4 tbsp White sugar

1 cup Warm water

1 Beaten egg

3 tbsp Milk

2 tsp Salt

Additional egg content may be added to increase product flexibility.

Preparation:

In a large bowl dissolve yeast in warm water. Beat until frothy. Stir in sugar, milk, egg, salt, and enough flour to make a soft dough Knead for 6 minutes on a lightly floured surface, or until smooth. Place dough in a well-oiled bowl cover with a damp cloth, and set aside to rise. Let it rise until the dough has doubled in volume.

Pinch off small amounts of dough to make 12 to 14 pieces. Roll into balls, and allow to rise again While the dough is rising, preheat the grill to high.

At grill side, roll one ball of dough out into a thin circle. Lightly oil the grill. Place dough on grill, and cook for 1½ minutes. Brush uncooked side with butter, and cook until done, another minute to par-bake.

Lefse Norwegian Flat Bread) (Par-Baked)

16 to 18 rounds

Ingredients:

3 cups Boiling water

½ cup Butter flavored shortening

1 cup Evaporated milk

1 tsp Salt

2 tsp White sugar

3 cups Dry potato flakes

3 cups All-purpose flour

¾ cup Wheat flour

Directions:

In a large bowl mix together the boiling water, shortening, milk, salt, sugar, and potato flakes. Place in the refrigerator until thoroughly chilled.

After dough is thoroughly chilled, add the flour, using a pastry blender to cut in. Divide dough into 3 equal size portions. Form into 3 logs. Chill thoroughly in the refrigerator.

Heat an electric griddle to 375 degree F. (190 degree C.).

Divide logs into 8 pieces. Roll to about the size of a 10-inch tortilla. Work additional flour into rounds as needed. Use care to press lightly with rolling pin when forming into rounds as they are much more tender than pie dough. The weight of a large rolling pin is nearly enough. Partially bake on griddle turning frequently, to dry slightly. Cool on clothe Cover with an additional cloth Stack pieces on top of each other as they are baked. The steam will create a more tender product.

Obviously, numerous modifications and variations of the present invention are possible in light of the above teachings. It is therefore understood that within the scope of the appended claims, the invention may be practiced otherwise than as specifically described herein.

What is claimed is:

1. A three dimensional cake sculpture product, which comprises:
a.) an edible baked base having a bottom, substantially vertical walls, and a top;
b.) an edible three dimensional sculpture presenting a distinguishable scene, said sculpture being of two portions, being a first portion and a second portion, said first portion being three dimensional and being located on said top of said base, and said second portion being two dimensional and being located on said substantially vertical walls wherein said second portion includes at least one edible substrate and at least one edible printed segment of said distinguishable scene on said substrate.

2. The three dimensional cake sculpture product of claim 1 wherein said first portion is selected from the group consisting of cake icing, cookies, wafers, jelly beans, candy and combinations thereof positioned to create a segment of said distinguishable scene.

3. The three dimensional cake sculpture product of claim 1 wherein said distinguishable scene is a head presentation of a stylized person.

4. The three dimensional cake sculpture product of claim 3 wherein said head presentation of a stylized person includes a top as said first portion and facial features as said second portion.

5. The three dimensional cake sculpture product of claim 4 wherein said top is selected from the group of three dimensional tops, consisting of hair, ears, headwear and combinations thereof.

6. The three dimensional cake sculpture product of claim 1 wherein said distinguishable scene is at least a part of a stylized animal.

7. The three dimensional cake sculpture product of claim 1 wherein said edible substrate wrap is an edible film wrap.

8. A three dimensional cake sculpture product, which comprises:
a.) an edible baked base having a bottom, substantially vertical walls, and a non-vertical top;
b.) a three dimensional sculpture presenting a distinguishable scene, said sculpture being of two portions, being a first portion and a second portion, said first portion being edible and being three dimensional and being located on said non-vertical top of said base, and said second portion being inedible, being two dimensional and being located on said substantially vertical walls wherein said second portion is an inedible, peelable portion containing at least one printed segment of said distinguishable scene on said substrate.

9. The three dimensional cake sculpture product of claim 8 wherein said first portion is selected from the group consisting of cake icing, cookies, wafers, jelly beans, candy and combinations thereof positioned to create a segment of said distinguishable scene.

10. The three dimensional cake sculpture product of claim 8 wherein said distinguishable scene is a head presentation of a stylized person.

11. The three dimensional cake sculpture product of claim 8 wherein said head presentation of a stylized person includes a top as said first portion and facial features as said second portion.

12. The three dimensional cake sculpture product of claim 11 wherein said top is selected from the group of three dimensional tops, consisting of hair, ears, headwear and combinations thereof.

13. The three dimensional cake sculpture product of claim 8 wherein said distinguishable scene is at least a part of a stylized animal.

14. The three dimensional cake sculpture product of claim 8 said inedible substrate wrap is and inedible film wrap.

15. A method of making a three dimensional cake sculpture product, which comprises:
a.) making an edible baked base in a shape having a bottom, substantially vertical walls and a non-vertical top;
b.) creating a three dimensional sculpture of a distinguishable scene on said base by applying a first portion of said sculpture to said top of said base in the form of a three dimensional portion of said sculpture, and applying a second portion of said sculpture to said substantially vertical walls in a flat, smooth, two dimensional outer surface, wherein said second portion is a substrate wrap with a print of a distinguishable scene thereon and is fully wrapped around said walls of said edible baked base.

16. The method of claim 15 wherein said second portion is an edible portion having an edible substrate and at least one edible printed segment of said distinguishable scene on said substrate.

17. The method of claim 15 wherein said second portion is an inedible peelable portion containing at least one printed segment of said distinguishable scene.

18. The method of claim 15 wherein said first portion of said sculpture is created by applying at least one application of cake icing and at least a second application of a decoration selected from the group consisting of another cake icing, cookies, wafers, jelly beans, candy and combinations thereof.

19. The method of claim 15 wherein said edible baked base is made by baking in a baking pan having a predetermined shape to create said bottom said substantially vertical walls, and said top.

21. The method of claim 15 wherein said distinguishable scene is selected from the group consisting of at least a portion of a stylized person, and at least a portion of a stylized animal.

22. An interlocking cake sideliner, which comprises:
a flat sheet of bakeable edible substrate, being a sideliner having at least four sides, including a top edge, a bottom edge, a first end and a second end, said first end having a first interlocking member and said second end having a second interlocking member that is interlockable with said first interlocking member.

23. The interlocking cake sideliner of claim 21 wherein said flat sheet has a general footprint shape, excluding said interlocking members, selected from the group consisting of rectangular, trapezoidal, parallelogram, and curved top and bottom trapezoidal.

24. The interlocking cake sideliner of claim 21 wherein said flat sheet has a first interlocking member that is one of a male and a female member and said second end having a second interlocking member that is the other of a male and a female member and is interlockable with said first interlocking member.

25. The interlocking cake sideliner of claim 21 wherein said flat sheet has a thickness of about 1/20 inch to about ⅛ inch and is made of a material selected from the group consisting of flatbread, crepe, pancake, wafer, sugar wafer, rice paper, pie crust, pita, tortilla, cornmeal, unleavened bread.

26. The interlocking cake sideliner of claim 21 wherein said flat sheet has a distinguishable scene printed thereon in bakeable edible print.

27. The interlocking cake sideliner of claim 25 wherein said flat sheet has a distinguishable scene printed thereon in bakeable edible print, and the sideliner further includes edible topping decoration that is complementary to said distinguishable scene.

28. The interlocking cake sideliner of claim 21 that further includes a separate flat sheet of bakeable edible substrate bottom having a shape and size compatible with an open bottom created when said wherein said flat sheet sideliner ends are interlocked with one another.

29. The interlocking cake sideliner of claim 27 wherein said flat sheet sideliner and said bottom have interlocking features that are complimentary.

30. The interlocking cake sideliner of claim 21 that further includes a connected flat sheet of bakeable edible substrate bottom having a shape and size compatible with an open bottom created when said wherein said flat sheet sideliner ends are interlocked with one another.

31. The interlocking cake sideliner of claim 29 wherein said flat sheet sideliner and said bottom have interlocking features that are complimentary.

32. A method of making a cake product, which comprises:
a.) providing a flat sheet of bakeable edible substrate, being a sideliner having at least four sides, including a top edge, a bottom edge, a first end and a second end, said first end having a first interlocking member and said second end having a second interlocking member that is interlockable with said first interlocking;
b.) interlocking said sideliner and placing it on a bakeware device;
c.) pouring bakeable cake material into said sideliner on said bakeware device and baking until baked.

33. The method of claim 31 wherein said flat sheet has a general footprint shape, excluding said interlocking members, selected from the group consisting of rectangular, trapezoidal, parallelogram, and curved top and bottom trapezoidal.

34. The method of claim 31 wherein said flat sheet has a first interlocking member that is one of a male and a female member and said second end having a second interlocking member that is the other of a male and a female member and is interlockable with said first interlocking member.

35. The method of claim 31 wherein said flat sheet has a thickness of about 1/20 inch to about 1/16 inch and is made of a material selected from the group consisting of flatbread, crepe, pancake, wafer, sugar wafer, rice paper, pie crust, pita, tortilla, cornmeal, unleavened bread.

36. The method of claim 31 wherein said flat sheet has a distinguishable scene printed thereon in bakeable edible print.

37. The method of claim 35 wherein said flat sheet has a distinguishable scene printed thereon in bakeable edible print, and the sideliner further includes edible topping decoration that is complementary to said distinguishable scene and is placed atop said cake material after it is baked.

38. The method of claim 31 that further includes providing a separate flat sheet of bakeable edible substrate bottom having a shape and size compatible with an open bottom created when said wherein said flat sheet sideliner ends are interlocked with one another, and said bottom is inserted into said sideliner after said sideliner is interlocked.

39. The method of claim 37 wherein said flat sheet sideliner and said bottom have interlocking features that are complimentary.

40. The method of claim 31 that further includes providing a connected flat sheet of bakeable edible substrate bottom having a shape and size compatible with an open bottom created when said wherein said flat sheet sideliner ends are interlocked with one another, and said bottom is assembled with sideliner when said sideliner is interlocked.

41. The method of claim 39 wherein said flat sheet sideliner and said bottom have interlocking features that are complimentary.
